(19) United States
(12) Patent Application Publication
(10) Pub. No.: US 2002/0133282 A1
(43) Pub. Date: Sep. 19, 2002

(54) Brake light system using sequential lamp array and input from velocity measuring device

(76) Inventors: John T. Ryan, Riverdale, NY (US); Robert M. Altman, New Canaan, CT (US); Ross J. Altman, New Canaan, CT (US)

Correspondence Address: LACKENBACH SIEGEL, One Chase Road, Scarsdale, NY, 10583, US

(21) Appl. No.: 09/810,019

(22) Filed: Mar. 16, 2001

(51) Int. Cl. G06F 19/00

(52) U.S. Cl. 701/70; 340/441

(57) ABSTRACT

The present invention relates to a brake lighting system that includes a light array which illuminates sequentially when a velocity measuring device, independent of the braking system, detects a change in velocity of the motor vehicle, and communicates the change in velocity to the array. The velocity measuring device includes, but is not limited to, a speedometer, an accelerometer, an odometer, an anti-lock braking system (ABS), or a global positioning system (GPS). The velocity measuring device produces velocity measurement data which is processed by a system clock, a velocity measuring device data interface, a pulse generator, at least two memory latches, a deceleration level detector, and a brake light interface in order to sequentially illuminate the brake light array.

### BACKGROUND OF THE INVENTION

1. Field of the Invention

The present invention relates to motor vehicle brake light systems. Specifically, the present invention relates to motor vehicle brake light systems wherein an array of brake lights at the rear of a motor vehicle is illuminated in response to a deceleration of a motor vehicle measured by a velocity measuring device, without a need for the deceleration to be due to a depression of a brake pedal.

2. Description of the Prior Art

A common cause of dangerous and often deadly traffic accidents involve motor vehicles that are driving in a consecutive fashion, with their respective drivers being unable to gauge the relative seriousness of a sudden stop on the part of a driver in front of them. A driver may apply the brakes of a motor vehicle for any number of reasons, either insignificant or serious. Examples of such reasons include animals darting in the path of the oncoming vehicle, slick or icy road conditions, localized distractions of the driver, potholes or cracks in the roadway, or simply, by accident. Unfortunately, for drivers directly behind such a motor vehicle, the visual cue is always the same. The brake lights are either “on” or “off,” with no indication as to whether the following motorist should merely slow down, or immediately slam on his own brakes to avert a potentially catastrophic accident. Qualitative and quantitative visual information is unable to be appreciated by a following motorist in most of the art today, and eventually motorists may become conditioned to either dismiss the seriousness of the brake light illumination as incidental, or perhaps overreact to the visual cue, thereby compromising the safety of both himself and other drivers on the road. In either case, these types of reactions are typical of motorists on the highways and roadways, and are leading causes of substantially most motor vehicle accidents and deaths every year.

Insufficient spacing between consecutive motor vehicles in traffic is also exacerbated due to the general inability of drivers to correctly gauge the potentiality for an accident, paving the way for over one-third of all resulting injuries and deaths on the road. Additionally, auto accidents that are caused by this type of “blind driving” boost the costs of general insurance coverage because of high premium charges and expensive repairs.

Therefore, improving the ability of a driver to distinguish between a serious and a mild traffic stop can proportionately increase a driver's ability to avoid an accident.

The severity of this problem has caused the United States Government to promulgate the use of high-mounted, third brake lights on all U.S. delivered motor vehicles after 1985. Tests relating to this type of brake light have demonstrated a greater recognition ability in drivers while improving their reaction times to potential accidents.

Various prior art vehicle lighting systems for addressing these problems have been suggested.

U.S. Pat. No. 4,918,424 to Sykora (Apr. 17, 1990) describes a two-stage brake light system for a vehicle with a brake pedal, wherein a switch is provided that energizes a warning light when the brake pedal is depressed by a first selected amount, and then energizes a stop light when the pedal has been depressed a second amount which is greater than the first amount. However, the apparatus described therein is limited in that the deceleration is limited to stopping with a brake pedal, which can often fail, or be susceptible to skidding, which can render any data obtained by this system to be inaccurate or misleading.

U.S. Pat. No. 5,150,098 to Rakow (Sep. 22, 1992) describes a brake signaling system and process using a sequential pressure monitoring brake light display to alert others of the relative frequency and amount of braking force applied during braking of the vehicle. However, as in Sykora, the brake light signal is dependent upon the mechanical exertion of a brake system, here a hydraulic brake system, onto an illuminating and signal means. The apparatus is not very accurate, because the mechanical data generated by the brake system can become skewed depending on the relative fitness of the hydraulic brake system. Varying exertion stress due to a faulty brake system will be transmitted to the pressure transducer, which aids in the translation of the exertion into data used by the lights. Therefore, a system and method for accurately gauging vehicle deceleration without depending on a fallible brake system would remedy the effects of inaccurate information provided by simple hydraulic brake pressure.

U.S. Pat. No. 5,831,523 to Lange (Nov. 3, 1998) describes a vehicle light system for use with a vehicle having a rear window with a periphery defined by a linear top edge, a linear bottom edge, and a pair of side edges formed there between. A plurality of spaced red light emitting diodes formed along the top edge of the rear window includes a first set of diodes situated to the left of a central extent of the rear window and a second set of diodes situated to the right of the central extent thereof. However, the red light emitting diodes are adapted to illuminate only during their actuation by a brake relay control mechanism after physical braking of the vehicle. Thus, here again, the illumination of the brake lights is directly coupled to the force exerted by the brake pedal, i.e., not to a separate and objective velocity measuring device containing impartial data relative to the vehicle speed and time in an analog or digital format. As was stated above, this type of system does not fully accommodate, or even contemplate, the inaccurate data potentially supplied by the brakes when they are not functioning in an optimum condition.

U.S. Pat. No. 5,838,259 to Tonkin (Nov. 17, 1998) describes a motor vehicle display system and ranging device wherein a display system for motor vehicles provides an array of lamps at the rear of a subject vehicle to provide an indication of the state of motion of the subject vehicle to the driver of a following vehicle. In a first mode of operation, the display indicates a level of warning dependent upon the rate of deceleration of the subject vehicle, the level of warning being determined by deceleration thresholds which are variable in dependence upon the measured speed of the subject vehicle. In a second mode of operation, the lamps provide an indication of the subject vehicle being stationary or near stationary as determined by comparing the measured speed with a threshold speed. An animate display is created by illuminating the lamps and sequentially deactuating selected pairs of lamps to create a pattern cyclically moving symmetrically outwardly from the center of the row. The display is discontinued when the speed of the subject vehicle exceeds a second threshold defined independently of the first threshold speed. In a third mode of operation, the display indicates that the subject vehicle is stationary or near stationary in a manner which has less prominence, fewer lamps being illuminated, and in response to detection of a following vehicle being in close proximity to the subject vehicle. However, the scope of Tonkin 1998 is substantially limited in that a processor operates to compare the measure of deceleration with a first set of set and predetermined deceleration thresholds defining a first set of distinct ranges of deceleration and to select a level of warning from a corresponding set of levels of warning according to the range of deceleration in which the measure of deceleration is determined to lie. This a cumbersome and potentially inaccurate task which can detract from the simple indication of data provided by a simple velocity measuring device. In Tonkin, the deceleration data, obtainable through the braking system, optimally, must undergo complex processing and comparisons with predetermined and set reference values. A need still exists for a syllogistic system wherein velocity data can be directly transferrable to sequential light array illumination, so that no reference values need be recorded or stored. Furthermore, Tonkin 1998 is even more limited in that the processor operates to determine the values of the first set of deceleration thresholds dependent upon the measure of velocity over an entire velocity range of the subject vehicle, which adds to potential inaccurate data transferral, thus leading to confusion, and consequently, more accidents.

U.S. Pat. No. 5,856,793 to Tonkin, et al. (Jan. 5, 1999) discloses a motor vehicle display system and ranging device wherein the state of motion of a motor vehicle is indicated to a driver of a following vehicle by employing an array of lamps. The state of motion is determined by sensing vehicle velocity, deceleration being measured either directly via a transducer or being derived from measured velocity. However, the scope of Tonkin 1999 is limited in that it is also contemplated that the approach of a following vehicle to within a pre-set distance of the stationary vehicle is sensed and triggers a change in the display to a static visual display in which an outer pair of lamps remain illuminated. This limitation can produce unfortunate results, in that the illumination of the brake lights are not dependent solely upon data derived solely from the subject vehicle, but are also dependent upon input from a vehicle following the subject vehicle, thus potentially providing inaccurate or faulty data to the lights. This can lead to even more dangerous conditions than without the system. The scope of the present invention is not so limited, and derives its data solely from an analog/digital velocity measuring device associated with the subject vehicle, and minimizes the chance that inaccurate or dangerous conditions will occur, or be exacerbated. Additionally, the scope of Tonkin 1999 is even more limited in that the measure of velocity of the subject vehicle must be de determined to be of a lesser value than a chosen reference value before the brake lights are illuminated. These steps cause the Tonkin 1999 system to again rely on other sources of data before the indication brake lights are illuminated, and creates other potentially dangerous conditions if the reference value comparisons do not proceed perfectly. Instead, the present invention seeks to directly couple the brake lights to a velocity measuring device, thus relying on direct analog/digital data to stimulate the lights in a quantitative and qualitative fashion, and not on ancillary or secondary sources of speed information for light actuation.

U.S. Pat. No. 6,018,295 to Jewell, et al. (Jan. 25, 2000) discloses a vehicle safety light system that includes at least one left and right light element, each having multiple light emitting devices, arranged in a row. However, the scope of Jewell is limited to that of lights being arranged on the sides of a subject vehicle, and therefore not providing any degree of protection for drivers of vehicles following the subject vehicle. Additionally, Jewell contemplates connectivity to a brake system for its raw data, and as was stated above, can lead to skewed data results.

U.S. Pat. No. 6,150,933 to Matsumoto (Nov. 21, 2000) describes a vehicle brake light system that includes a plurality of lamps arranged in endless array, a brake pedal linkage operable in response to depression of a brake pedal and a controller operable to effect brief illumination of the lamps in sequence around the array in response to operation of the brake pedal linkage. The rate at which the lamps are sequentially illuminated increases in accordance with the magnitude of the brake actuation pressure. However, the scope of Matsumoto is also limited in that the array of lights are contemplated to be arranged in a circular fashion on the back of the vehicle, thus defeating the purpose the present invention, a qualitative and quantitative linear measurement of vehicle deceleration. More importantly, the illumination of the lights is directly coupled to the brake pedal, thus leading to the severe inaccuracies and skewed visual results as described above.

U.S. Pat. No. 6,133,852 to Tonkin (Oct. 17, 2000) describes a motor vehicle system and ranging device wherein a display system for motor vehicles provides an array of lamps at the rear of a subject vehicle to provide an indication of the state of motion of the subject vehicle to the driver of a following vehicle. However, as in the other Tonkin patents, the Tonkin 2000 patent is also extremely limited. For example, the lamps provide an indication of the subject vehicle being stationary or near stationary as determined by comparing the measured speed with a predetermined, set and unalterable threshold speed. This can be extremely cumbersome and can contribute to seriously skewed and faulty data to the lights, whereas a simple circuit link with simple variable resistors would eliminate the chance of inaccuracy. Additionally, the display is discontinued when the speed of the subject vehicle exceeds a second predetermined, set and invariable threshold defined independently of the first threshold speed. In a much more severe limitation, the display indicates that the subject vehicle is stationary or near stationary in a manner which has less prominence, fewer lamps being illuminated, and in response to detection of a following vehicle being in close proximity to the subject vehicle.

A need therefore exists for a brake light system wherein an array of brake lights arranged on the back of a motor vehicle provides a qualitative and quantitative visual cue of vehicle deceleration, wherein the system avoids the dependence of a direct coupling to inaccurate mechanical exertions associated with a brake system, such as hydraulic or pneumatic brake systems. A need exists for a system that uses analog or digital data from a velocity measuring device associated with the subject vehicle, the velocity measuring device being coupled to the brake lights in order to remedy the unpredictable effects associated with potentially inaccurate data from brake originated data. The system must be dependent solely upon the data provided by the subject vehicle, and not on potentially disastrous third-party data, such as from other vehicles or predetermined and set reference values, which can skew results and defeat safety.

### SUMMARY OF THE INVENTION

It is therefore an object of the present invention to provide a lighting system on a motor vehicle that includes an array of light emitting elements, a velocity measuring device, and a communicating means between the measuring device and the array, wherein the measuring device communicates a decrease in velocity of the vehicle through the communicating means, the decrease causing the elements to illuminate sequentially.

It is another object of the present invention to provide a lighting system as described above wherein the communicating means is a brake light processing unit.

It is another object of the present invention to provide a lighting system as described above wherein the brake light processing unit further includes a system clock, a velocity measuring device data interface, a pulse generator, at least two memory latches, a deceleration level detector, and a brake light interface, wherein the velocity measuring device provides velocity data of the vehicle which is processed by the velocity measuring device data interface, the clock, the pulse generator, the at least two memory latches, the deceleration level detector, and the brake light interface in order to sequentially illuminate the array.

It is another object of the present invention to provide a lighting system as described above which further includes a brake pedal that depresses to produce a change in pressure, and a brake pedal switch unit that transmits the change in pressure to the array, wherein the change in pressure causes the array to illuminate sequentially.

It is another object of the present invention to provide a lighting system as described above wherein the array is arranged in a linear fashion.

It is another object of the present invention to provide a lighting system as described above wherein the array is arranged in a circular fashion.

It is another object of the present invention to provide a lighting system as described above wherein the array is arranged in a concentric fashion.

It is another object of the present invention to provide a lighting system as described above wherein the array is a radial formation.

It is another object of the present invention to provide a lighting system as described above wherein the array comprises a center light emitting element and at least two other light emitting elements, the central light emitting element supplying the current for the at least two other light emitting elements.

It is another object of the present invention to provide a lighting system as described above wherein the measuring device is a speedometer.

It is another object of the present invention to provide a lighting system as described above wherein the measuring device is an accelerometer.

It is another object of the present invention to provide a lighting system as described above wherein the measuring device is a global positioning system (GPS).

It is another object of the present invention to provide a lighting system as described above wherein the measuring device is an anti-lock braking system (ABS).

It is another object of the present invention to provide a lighting system as described above wherein the measuring device is an opto-switch.

It is an object of the present invention to provide a method for brake lighting a motor vehicle, including the steps of measuring a change in velocity of the motor vehicle with a measuring device, communicating through a communicating means the change in velocity to an array of light emitting elements, and illuminating sequentially the array of light emitting elements due to the change in velocity.

It is another object of the present invention to provide a method for brake lighting a motor vehicle as described above, wherein the communicating means is a brake light processing unit.

It is another object of the present invention to provide a method for brake lighting a motor vehicle as described above, wherein the brake light processing unit further includes a system clock, a velocity measuring device data interface, a pulse generator, at least two memory latches, a deceleration level detector, and a brake light interface, wherein the velocity measuring device provides velocity data which is processed by the velocity measuring device data interface, the clock, the pulse generator, the at least two memory latches, the deceleration level detector, and the brake light interface to sequentially illuminate the array.

It is another object of the present invention to provide a method for brake lighting a motor vehicle as described above, wherein the method further includes the steps of depressing a brake pedal to produce a change in pressure and communicating the change in pressure using a brake pedal switch unit to the array, wherein the change in pressure causes the array to illuminate sequentially.

It is another object of the present invention to provide a method for brake lighting a motor vehicle as described above, wherein the array is arranged in a linear fashion.

It is another object of the present invention to provide a method for brake lighting a motor vehicle as described above, wherein the array is arranged in a circular fashion.

It is another object of the present invention to provide a method for brake lighting a motor vehicle as described above, wherein the array is arranged in a concentric fashion.

It is another object of the present invention to provide a method for brake lighting a motor vehicle as described above, wherein the array is arranged in a radial formation.

It is another object of the present invention to provide a method for brake lighting a motor vehicle as described above, wherein the array comprises a center light emitting element and at least two other light emitting elements, the central light emitting element supplying the current for the at least two other light emitting elements.

It is another object of the present invention to provide a method for brake lighting a motor vehicle as described above, wherein the measuring device is a speedometer.

It is another object of the present invention to provide a method for brake lighting a motor vehicle as described above, wherein the measuring device is an accelerometer.

It is another object of the present invention to provide a method for brake lighting a motor vehicle as described above, wherein the measuring device is a global positioning system (GPS).

It is another object of the present invention to provide a method for brake lighting a motor vehicle as described above, wherein the measuring device is an anti-lock braking system (ABS).

It is another object of the present invention to provide a method for brake lighting a motor vehicle as described above, wherein the measuring device is an opto-switch.

### BRIEF DESCRIPTION OF THE DRAWINGS

Embodiments of the present invention are described below with reference to FIGS. 1 through 10.

FIG. 1 illustrates a general schematic diagram of the brake light system using a sequential lamp array and input from a velocity measuring device, as contemplated by the present invention.

FIG. 2 is a more detailed illustration of the brake light system contemplated herein, wherein the velocity measuring device is a speedometer.

FIG. 3 is a more detailed illustration of the brake light system contemplated herein, wherein the velocity measuring device is an accelerometer.

FIG. 4 is a more detailed illustration of the brake light system contemplated herein, wherein the velocity measuring device is a global positioning system (GPS).

FIG. 5 is a cross-sectional view of an individual brake light contemplated by the present invention.

FIG. 6 is a rear view of a motor vehicle wherein the vehicle has a brake light system using a sequential lamp array and input from a velocity measuring device, as contemplated herein, with a lamp array.

FIG. 7 is a closer view of the view originally appearing in FIG. 6, with more emphasis placed on the details of the sequential lamp array unit, the unit being arranged in an arcuate pedestal.

FIG. 8 is an alternate closer view of the view originally appearing in FIG. 7, with more emphasis placed on the details of the sequential lamp array unit with different variables thereof.

FIG. 9 is an abbreviated schematic showing the mechanical and physical relationships between the brake light array, the brake light interface, and control means for sequentially illuminating the individual brake lights, as contemplated in the present invention.

FIG. 10 is a detailed illustration of the electro-mechanical relationship of the lighting system wherein a stimulus, either from the brake system or the velocity measuring device, causes the lights to illuminate sequentially.

### DETAILED DESCRIPTION OF THE PREFERRED EMBODIMENTS

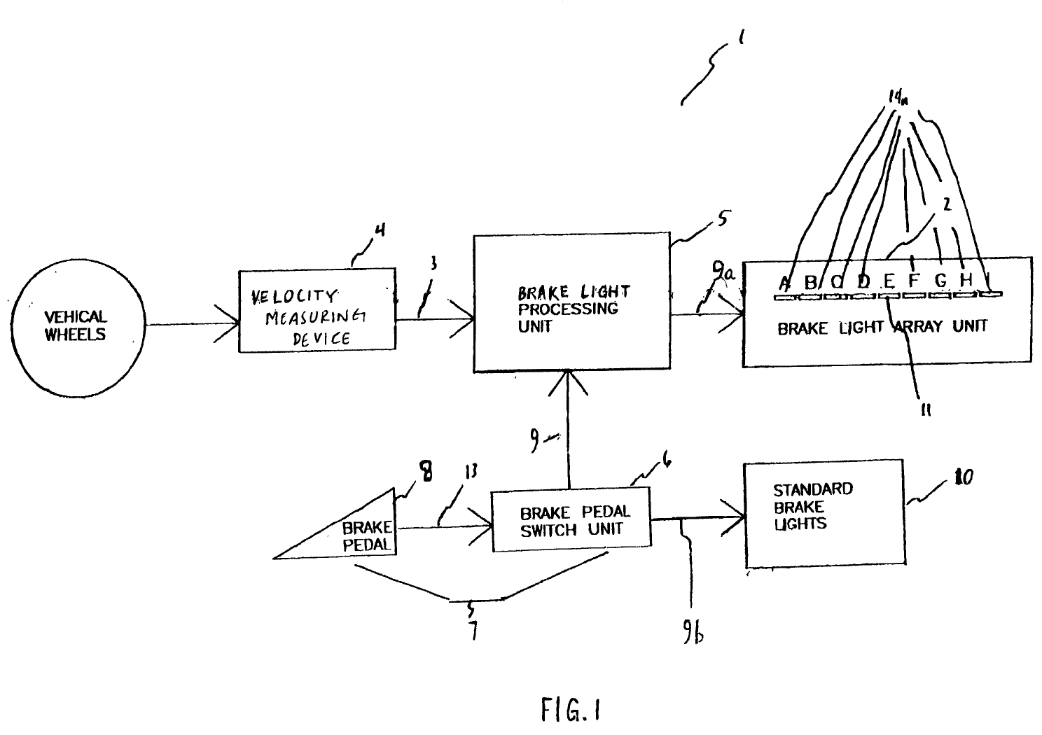

FIG. 1 illustrates a schematic of the preferred embodiment of the brake light system 1 for use with a wide variety of motor vehicles, including, but not limited to, vans, sport utility vehicles, regular automobiles, trucks, recreation vehicles, and any other combustion vehicle. The system uses a sequential lamp array 2 and velocity input data 3 from a velocity measuring device 4 (may be a speedometer, accelerometer, global positioning system (GPS), odometer, or an anti-lock braking system (ABS), each embodiment discussed infra). A brake light processing unit 5 receives input data 3 from both the velocity measuring device 4 and the brake pedal switch 6. However, the processing unit 5 is dependent upon the velocity measuring device 4 for its velocity data input 3. The brake pedal apparatus 7 is not a necessary part of the invention contemplated herein. The brake pedal 8 and its corresponding mechanisms will be discussed within the present invention, however, for purposes of utility and prior art reference.

When the brake pedal 8 is depressed slightly the brake pedal switch unit 6 is activated sending a signal 9 to the brake light processing unit 5, as well as a brake signal 9b to the standard brake lights 10. The brake light processing unit 5 sends a processed signal 9a to the brake light array 2 that causes the center light 11 to illuminate. If the brake pedal 8 is depressed more, it will cause the vehicle to decelerate more, and this deceleration data 13 will be fed into the brake light processing unit 5 via the brake pedal switch unit 6. However, velocity input data 3 from the velocity measuring device unit 4 will be input to the brake light processing unit 5 as well, and the velocity input data 3 will be independent of the brake pedal deceleration data 13.

The brake light processing unit 5 will in turn compute the rate of deceleration, and then send a processed signal 9a to the brake light array unit, causing the next light emitting elements 14n to illuminate in addition to the center light 11. If the brake pedal 8 is depressed even more, it will cause the vehicle to decelerate even more so, and velocity input data 3 from the velocity measuring device unit 4 will be input to the brake light processing unit 5, which will compute the increased rate of deceleration, and then send a processed signal 9a to the brake light array unit 2, that causes more of the outer lights 14n to illuminate. When the brake pedal 8 is released completely, all of the brake lights 11, 14n will be off. However, if the velocity measuring device 4 still contains and is capable of transmitting active velocity input data 3 to the brake light processing unit 5, the lights will still illuminate sequentially.

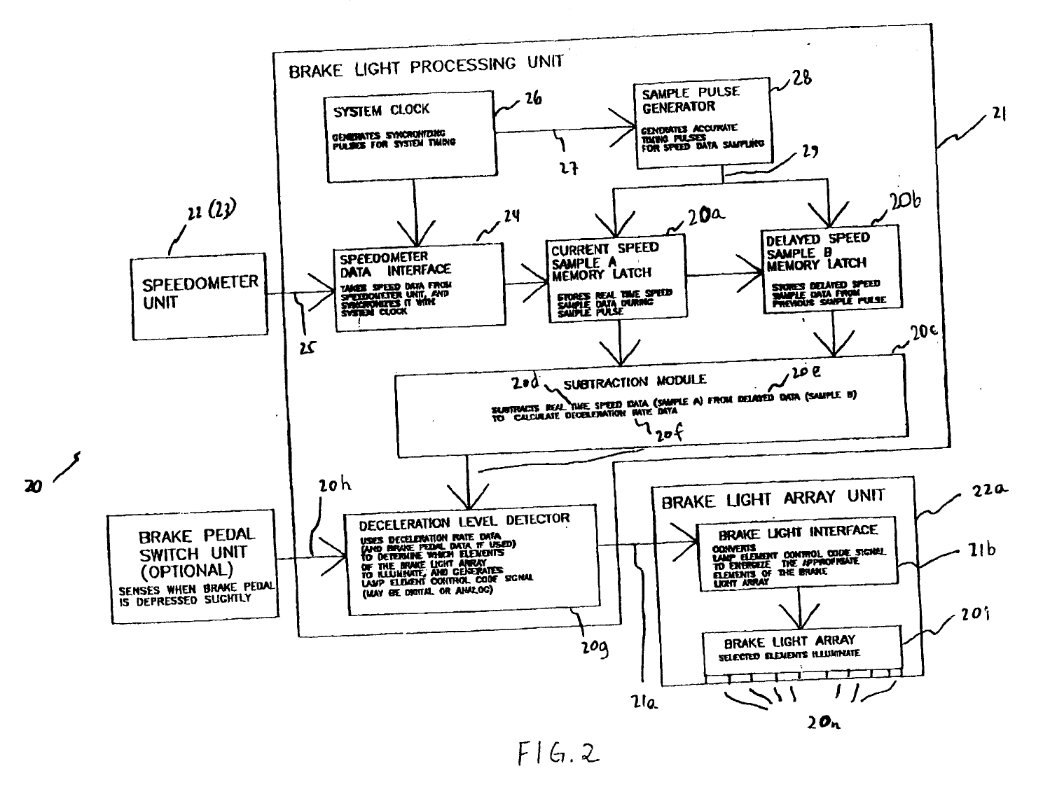

Referring to FIG. 2, there is illustrated a more detailed functional block diagram of the brake light system 20 contemplated herein, with a brake light processing unit 21 and a velocity measuring device 22, the velocity measuring device being here a speedometer unit 23. The speedometer unit 23 connects into a speedometer data interface 24. This speedometer data interface 24 takes velocity input data 25 from the speedometer unit 23 and then synchronizes it with a system clock 26.

The system clock 26 generates synchronizing pulses for system timing, and sends input 27 to a sample pulse generator 28. The pulse generator 28, can be a Tektronix 73A270, such as an arbitrary pulse/pattern generator module, with two independent programmable output channels, TTL and level-programmable bipolar outputs to ±±17.4 V for each channel, time duration values which can be updated “on-the-fly,” and is amenable to VXI plug&play, WIN, WIN95 and WINNT Frameworks. Ideally, the 73A270 Arbitrary Pulse/Pattern Generator (APPG) Module provides two completely independent output channels that can be individually programmed to generate arbitrary bipolar or TTL serial data patterns. The pulse generator generates accurate timing pulses for speed data sampling, i.e., digital square pulses used to calculate the vehicle velocity, provides this data input 29 into a current speed memory latch 20a and delayed speed memory latch 20b. The current speed memory latch 20a stores real time speed sample data during sample pulse, whereas the delayed speed memory latch 20b stores delayed speed sample data from a previous sample pulse.

Inside a subtraction module 20c, the real time speed 20d is subtracted from the delayed speed data 20e in order to calculate the deceleration rate data 20f. This deceleration rate data 20f is then fed into a deceleration level detector 20g which uses the deceleration rate data 20f (and the brake pedal data 20h if its used) to determine which elements 20n of the brake light array 20i will be illuminated, and generates a lamp element control code signal 21a (may be digital or analog).

The brake light array unit 22a has a brake light interface 21b, which converts the lamp element control code signal 21a to energize the appropriate elements 20n of the brake light array 20i, wherein selected elements 20n illuminate.

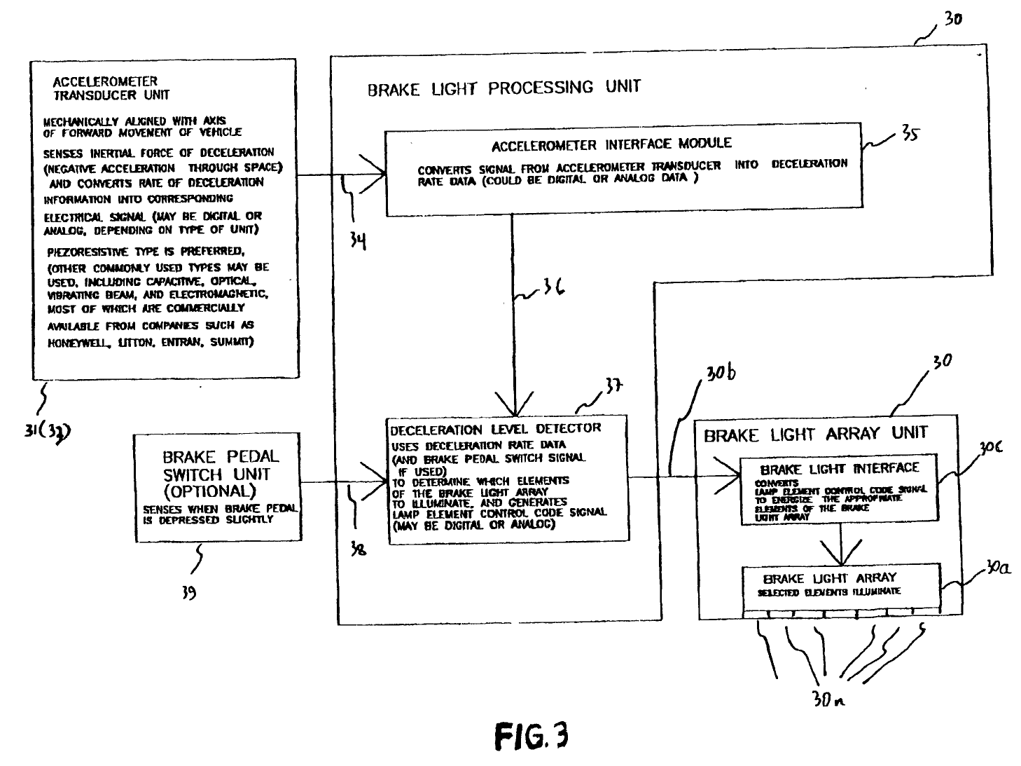

Turning to FIG. 3, there is a functional block diagram of the brake light processing unit 30 where the velocity measuring device 31 is an accelerometer transducer unit 33, and is mechanically aligned with the axis of a forward moving vehicle (not shown). The accelerometer transducer unit 33 senses inertial forces of deceleration (negative acceleration through space) and converts the rate of deceleration information into an electronic signal 34, which can be either digital or analog.

The accelerometer unit 33 is preferably piezoresistive, or may be capacitative, optical, vibrating beam, or electromagnetic, most of which are commercially available from companies such as Honeywell, Litton, Entran, and Summit, among others. The accelerometer 33 deposits this electronic signal 34 into a brake light processing unit 30, wherein an accelerometer interface 35 converts the electronic signal 34 into a deceleration rate data 36 in either digital or analog form. A deceleration level detector 37 uses this deceleration rate data 36 (and brake pedal data 38 from a brake pedal switch unit 39, which is optional), and determines which elements 30n in the brake light array 30a to illuminate, and then generates a lamp element control code signal 30b, the code being in either digital or analog format. This code 30b is transmitted to a brake light array unit 30a, wherein a brake light interface 30c converts the lamp element control code 30b in order to energize the appropriate elements 30n of the light array 30a, wherein the selected lights 30n illuminate.

The accelerometer 33 can be an EGE-73, with a built-in 1/2-bridge of fixed resistors suitable for shunt calibration and compatible with many systems. It is ideal for general purpose use, particularly for both high output and high frequency; and the accelerometer unit may be a piezo-resistive seismic mass type.

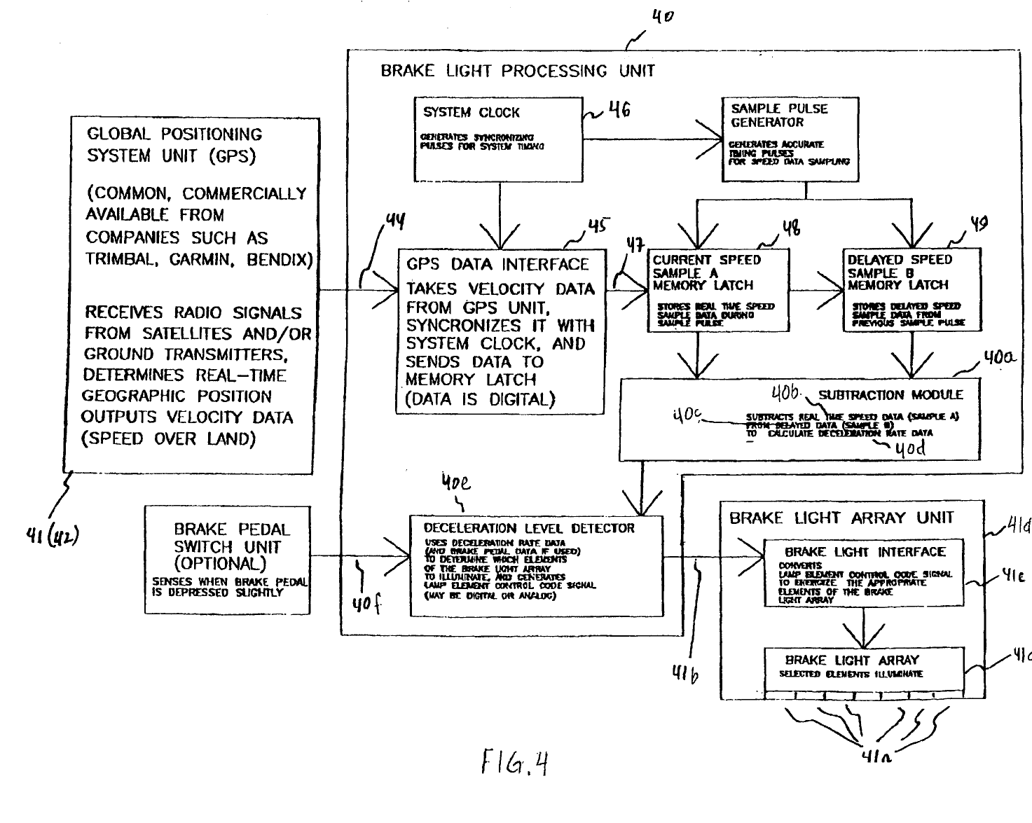

FIG. 4 illustrates a functional block diagram of the brake light processing unit 40 where the velocity measuring device 41 is a global positioning system (GPS) 42. Here, the global positioning system 42, commercially available from Trimbal, Garmin, or Bendix for example, receives radio signals from satellites and ground transmitters (not shown), and determines real-time geographic position output velocity data (speed over land) 44. Measuring the distance between a certain target and an observation point using GPS signals is faster, convenient and more accurate than conventional approaches. The well-known Navstar GPS includes twenty-four spacecraft in orbits inclined at fifty-five degrees to the Equator.

The inclined orbits provide worldwide coverage, including the North and South poles. The GPS system allows a user anywhere on Earth to receive the transmissions of at least four satellites at once. Triangulation mathematical calculations with these satellites provide a very accurate reading of position and velocity in three dimensions. Control stations around the world keep GPS satellites precisely calibrated and their orbits aligned.

Each GPS satellite contains an atomic clock and transmits a continuous time signal and other information to receivers on Earth. The receiver must acquire and track these signals, decode the data, and then make range and velocity calculations. As used herein GPS satellites as radiation sources and GPS receivers to form a passive radar system. GPS signals have two unique characteristics which are desirable in passive range measuring. First, the signals are always available from four or more different satellites. Second, the GPS continuous time coarse/acquisition (C/A) signal has a period of 1 millisecond, thus, theoretically it is possible to measure distance every millisecond. The Navstar system satellites have been launched into medium-altitude earth orbits in six orbital planes, each tipped 55 degrees with respect to the equator, and the complete GPS satellite constellation comprises twenty-one satellites and several spares, for 24, as described above. Signals transmitted from these satellites allow a receiver near the ground to accurately determine time and its own position. Each satellite transmits data that provides precise knowledge of the satellite position and allows measurement of the distance from that satellite to the antenna of the user's receiver. With this information from at least four GPS satellites, the user can compute its own position, velocity and time parameters through, for example, the navigation solution. Typically, seven, but a minimum of four, satellites are observable by a user anywhere on or near the earth's surface if the user's receiver has an unobstructed view of the sky, down to very near the horizon. Each satellite transmits signals on two frequencies known as L1 (1575.42 MHz) and L2 (1227.6 MHz), and all satellites share these frequencies using the CDMA DSSS techniques, not described here.

Because of these two characteristics, one can use GPS signals to measure distance at any location, any time and perform updates frequently. The velocity data obtained in this, or any other fashion using GPS, is input into a GPS data interface 45. The GPS data interface 45 takes the velocity data 44 from the GPS unit and synchronizes it with a system clock 46, and sends the processed data 47, which is in a digital format, to into a current speed memory latch 48 and delayed speed memory latch 49.

The current speed memory latch 48 stores real time speed sample data during sample pulse, whereas the delayed speed memory latch 49 stores delayed speed sample data from previous sample pulse. Inside a subtraction module 40a, the real time speed 40b is subtracted from the delayed speed data 40c in order to calculate the deceleration rate data 40d. This deceleration rate data 40d is then fed into a deceleration level detector 40e which uses the deceleration rate data 40d (and the brake pedal data 40f if its used) to determine which elements 41n of the brake light array 41a will be illuminated, and generates a lamp element control code signal 41.2 (may be digital or analog).

The brake light array unit 41d has a brake light interface 41c, which converts the lamp element control code signal 41b to energize the appropriate elements 41n of the brake light array 41a, wherein selected elements 41n illuminate.

Additionally, although not shown herein, the brake light array may be illuminated from an anti-lock braking system (“ABS”, and not shown). Commonly used ABS components can be modified to provide the information required by the array. Anti-lock braking systems typically comprise a device connected to a wheel hub which device rotates with the wheel to provide an electronic signal proportional to the rate of revolution of the wheel, for example by using an electromagnetic inductive technique. For ABS purposes it is only required to know if the wheel locks. However, for the purposes of the present invention, greater information about the vehicle's speed is required in order for deceleration to be calculated. Therefore, modification of the ABS inductive device can be carried out to provide appropriate information in the device output signal.

It is possible to continuously measure the speed of a vehicle from this source and then calculate acceleration using a time reference. It would then be possible to use this source to drive a logic circuit to illuminate and deactivate the array. This technique has the benefit that it substantially uses a system already fitted to generate relevant vehicle data independent of the actual braking system itself. It may therefore be readily incorporated during manufacture and has the advantage of reducing the cost of the display system itself.

However, as previously described some modification of currently available ABS devices may be required in order to specifically enhance the signal generated using such a device. In particular it may be necessary to increase the sampling rate of the ABS device in order to provide a signal of sufficient variability to enable preset ranges of deceleration/acceleration to be distinguished. In a preferred form the array system would derive input data from ABS devices attached to diagonally opposite wheels on a vehicle.

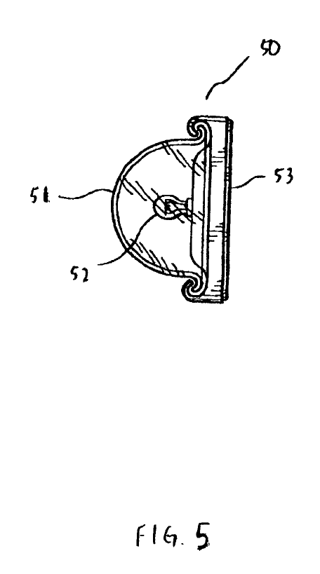

FIG. 5 illustrates a cross-section of one type of embodiment of an individual brake light 50 contemplated herein. Preferably, the brake light 50 is an electroluminescent bulb 52 that irradiates light through a translucent colored filter 51. Or the light source can be light emitting diodes (LEDs), or mini-lamps. The back portion 53 can be attached to the vehicle. Each light source can be 12V 5 W (or 21 W).

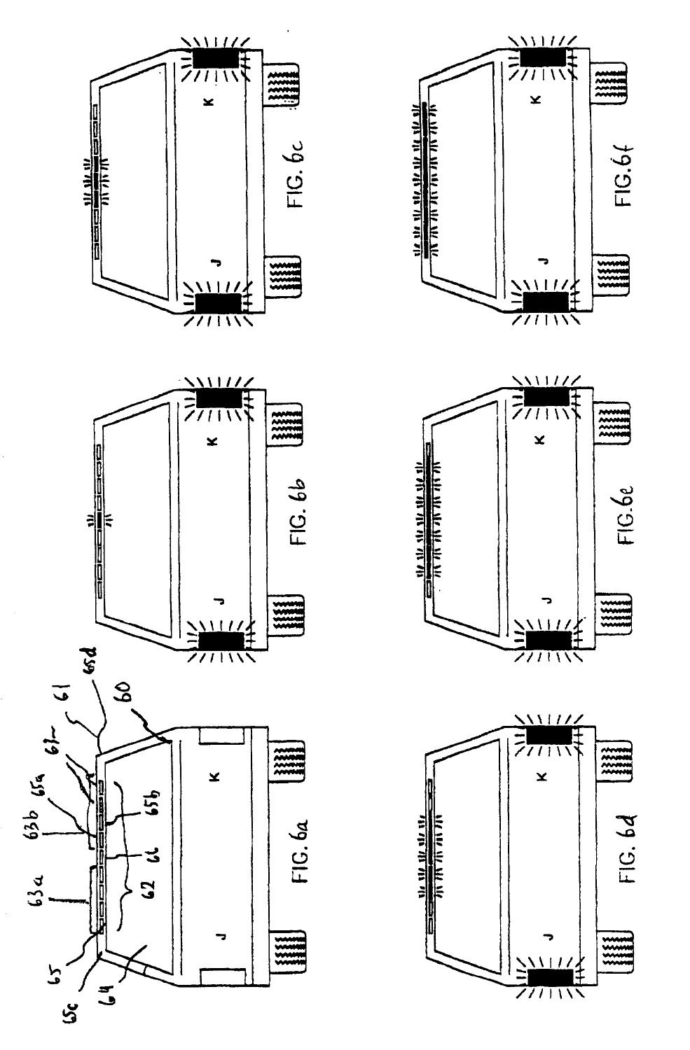

FIGS. 6a-6f show the rear 60 of a motor vehicle 61, where the array 62 of brake lights 63n can include at least three, and preferably eight, brake lights 63n mounted on the rear 60 of the motor vehicle 61. The lights, as can be seen in the figures increasing from 6a to 6f, illuminate sequentially during their actuation. The vehicle 61 has a rear window 64 with a periphery 65. The periphery 65 is defined by a linear top edge 65a, a linear bottom edge 65b, and a pair of side edges 65c, 65d.

The array 62 of spaced lights 63n are positioned along the top edge 65a and the side edges 65c, 65d of the rear window 64. The lights 63n include a first set of lights 63a situated to the left of a central light 66 of the top rear window 66.1 and a second set of lights 63b situated to the right of the central light 66 thereof. The lights 63n are adapted to illuminate only during their actuation thereof. The brake lights 63n are preferably tinted or colored red, although other colors can be used.

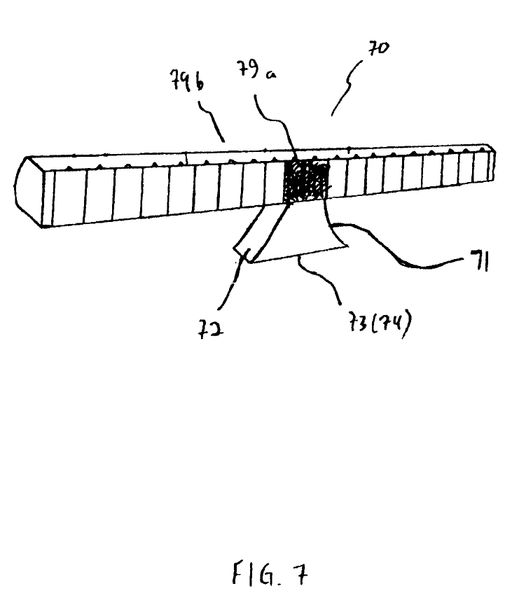

In FIG. 7, the array 70 can be mounted on an arcuate pedestal 71 with concave downwardly diverging sides 72 and a rectangular base 73 with a planar or flat bottom 74. The array 70 can be positioned and mounted upwardly in the rear window of the vehicle. Alternatively, the array 70 can be mounted on the vehicle's exterior above the trunk, in proximity to the rear window or adjacent to the rear bumper and taillights.

A progressive increase in the number of lights which are illuminated is dependent upon the magnitude of deceleration of the vehicle without blocking driver visibility. The lights are represented as “on” 79a in the drawings by dark colored boxes, compared to “off” 79b which is indicated by a colorless box. The array 70 may contain lights of different colors, though red or amber lights are preferred.

One of the advantages of the array system contemplated herein is that it can be mounted in a vehicle during manufacture, or even at a later time by making minor modifications to the vehicle, so that a retrofit unit or kit could be made available for an after sales market. This is made possible further since deceleration can be detected by the velocity measuring device which is independent of any existing vehicle components. Any mountings of the system can be made more cost-effective than connections with the physical braking system if the connections are solely via the velocity measuring device.

The array of lights are situated at the rear of a vehicle such as in the standard high level brake light position in the rear window of a motor car, for example. The lights face rearwardly and are located so that they are readily visible to an observer, e.g. the driver of a motor vehicle traveling or positioned behind the motor vehicle in which the lighting display is mounted. The lights are lit from the central light out to outer pairs during a progressive brake pressure and consequent vehicle deceleration. As the vehicle slows down, the deceleration is indicated by the number of lights which are lit. Gentle deceleration causes the illumination of the central light, and slightly harder braking and therefore greater deceleration causes the outer lights to be illuminated in sequential fashion, with a point of origin being the central light. An abrupt stop of the vehicle caused for example by firm depression of a brake pedal causes further or all of the lights to be actuated, the latter of which can occur when either the brakes are slammed in an emergency or when the velocity measuring device goes to zero abruptly.

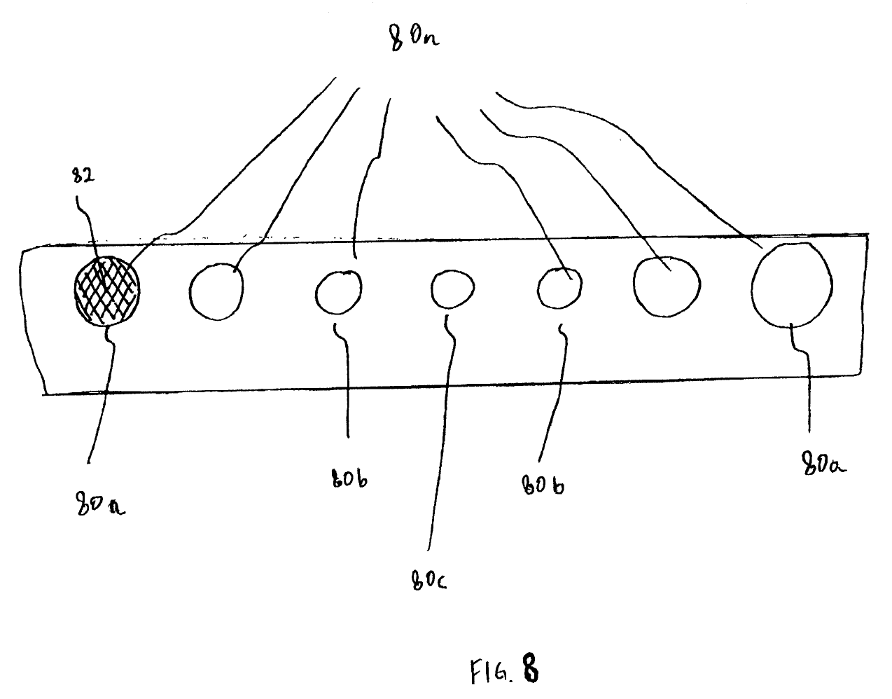

FIG. 8 shows, alternatively, other ways of indicating progressive deceleration, which might be to vary the relative sizes of the lights 80n. For example, the outer lights 80a can be larger than the inner lights 80b, sequentially, so that the outer lights 80a are the largest. This visual cue can enhance the effect of the illuminated array by emphasizing the more rapid deceleration of the vehicle 81 and its increasing proximity to trailing vehicles.

Alternatively, each light 80n may be of a different color, shade or intensity in relation to the other lights. For example, different tones of amber might be used starting from a light shade for the central light 80c, gradually darkening with respect to the adjacent outer lights 80a irradiating therefrom, until the extreme outermost lights are substantially red. Additionally, the relative intensity of the lights could be altered so that the outermost lights 80a would be brighter than the central light 80c. Or alternatively, a combination of these variable visual cues could be implemented to heighten the dramatic illumination effect.

The lights 80n can be electroluminescent bulbs which radiate light through translucent, colored filters 82. Alternatively, reflective lights might be used having phosphorescent targets, these types of lights being able to reduce the effect of dazzle of the display. Other light source choices could include light emitting diodes. The array can also incorporate a control means (not shown) which could vary the intensity of the overall array from a bright day setting to a night-time setting.

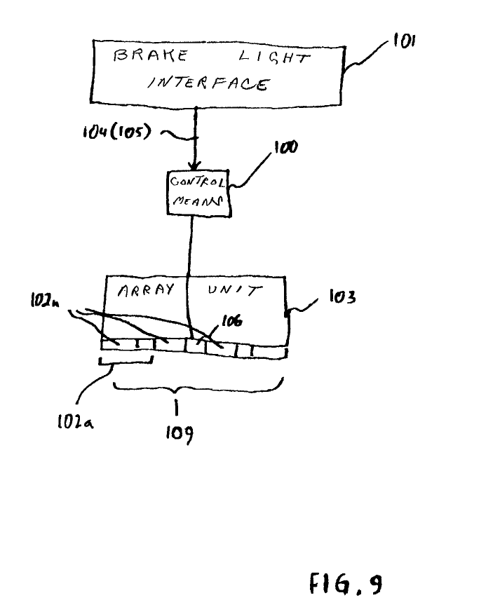

In FIG. 9, a brake control means 100 is connected between the brake light interface 101 and the lights 102n, all within the brake light array unit 103. The brake control means 100 serves to actuate the lights 102n in sequence upon the receipt of the activation signal 104, which is the lamp element control code signal 105 which was created by the brake light interface 101. The lights 102n are actuated in sequence from the central light 106 at the top edge 107 of the rear window 108 to the outermost lights 102a sequentially.

Once the lights 102n are all actuated, the lights 102n remain illuminated until the user of the vehicle removes pressure from the brakes or the velocity measuring device becomes active again (not shown). In other words, upon the receipt of the deactivation signal, which is the absence of brake pedal pressure or velocity measuring device signal at non-zero velocity, and concurrently an open relay (also not shown), the brake control means 100 is adapted to cease the actuation of the lights 102n.

The brake control means 100 may contain a plurality of D-flip flops (not shown) with an output connected to the associated central light 106 . Coupled between the lights 102n in the array 109 and the output of the associated D-flip flop is a TTL inverter (not shown) for allowing current to flow through the array 109 when the output gets higher.

The input of the first D-flip flop is connected to the voltage source (not shown). Each D-flip flop has a clear input connected to the brake control means 100 for receiving the activation and deactivation signals. Each D-flip flop is adapted to clear the output thereof upon the receipt of the deactivation signal and further allow the operation of the D-flip flop as a pass gate upon the receipt of the activation signal. Finally, a trigger input of each of the D-flip flops is connected to an oscillator (not shown).

Each D-flip flop of the brake control means 100 is adapted to act as a pass gate to pass the high input from the voltage source to the output thereof upon each rising edge of the associated clock pulse of the oscillator. As such, the high input is passed from D-flip flop to D-flip flop upon each receipt of the clock pulse thereby actuating the corresponding lights 102n in sequence.

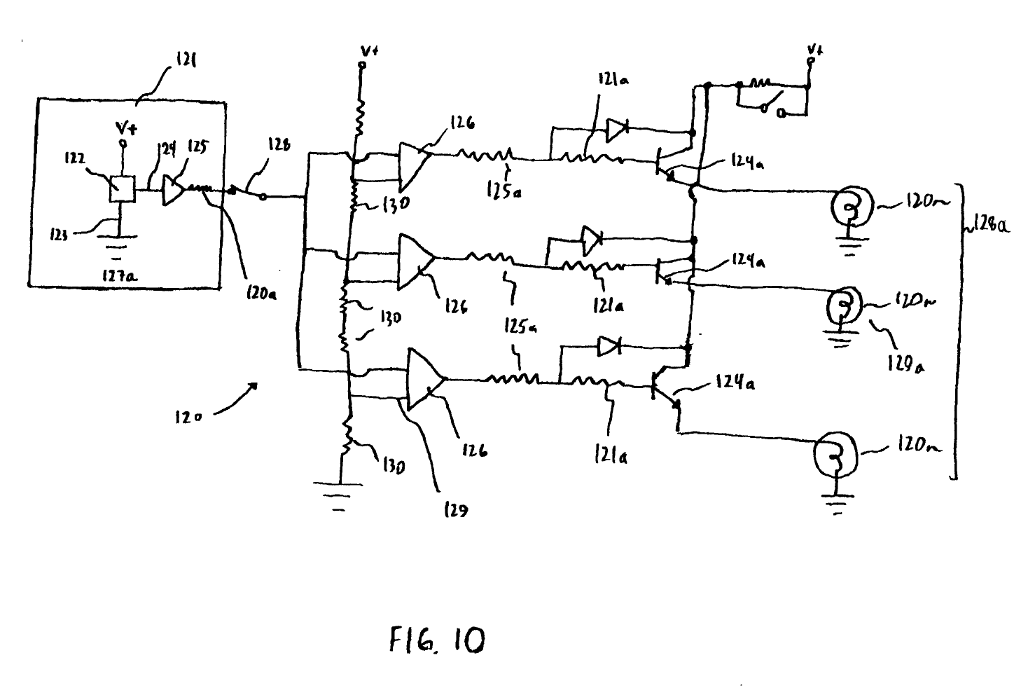

In FIG. 10 a signaling electric circuit 120 which can optionally illuminate the lights 120n in the light array 128a, is operatively connected to the hydraulic brake system 121 or the velocity measuring device (not shown).

The electric circuit 120 has a pressure transducer 122 coupled to the hydraulic brake system 121, to sense hydraulic braking pressures 123 in the hydraulic brake fluid 127a and produce a voltage 124. This voltage 124 can also be generated by the velocity measuring device (not shown). A low-noise amplifier 125 can amplify the voltage 124 produced by the transducer 122 or the velocity measuring device to produce an amplified voltage 120a.

A parallel set of level comparators and detectors 126 are connected through a normally closed emergency switch 128 to the low-noise amplifier 125 and are connected by lines 129 to resistors 130. The level comparators 126 compare the amplified input voltage 120a from the pressure transducer 122 or velocity measuring device with reference voltage levels in resistors 130 and then generate output current when the reference voltage levels are exceeded by the amplified input voltage. The output current is amplified by current drivers and amplifiers 124a to activate the brake array signal lights 120n. The output 122a of each level comparator 126 has a series of resistors including a trailing upstream resistor 125a and a leading downstream resistor 121a.

The leading downstream resistor 121a is connected and coupled thereon to a light 120n and is directly connected in series to a current amplifier comprising a transistor. Each of the brake light lamps 120n can be connected to a separate level comparator, current amplifier, trailing and leading resistor.

In summary, the velocity measuring device, or the pressure transducer 122 used to detect the pressure 123 in the hydraulic brake fluid 127a, provides a voltage output 124 which is a function of the fluid pressure 123. The voltage 124 has to be amplified by an amplifier 125 to produce an amplified voltage 120a before it can be used to drive the lamps 120n. This is achieved by the low-noise amplifier 125, which delivers a voltage signal.

The level comparators 126 then compare this voltage with a number of reference voltage levels in an ascending order. The output of a level comparator 126 will register either a high or a low output. Those with a high output will activate the current amplifier to light up the appropriate lamps 120n. The array 128a then lights up in a sequential manner.

The transducer 122 or the velocity measuring device acts essentially as a device that receives energy from one system and retransmits it in another form to another system. In this case, the velocity measuring device, or the transducer 122 receiving energy from the hydraulic brake system 121, produces electrical energy that would be transmitted to the electrical system.

The initial activation of the brake system 121 with slight braking force and pressure 123, would illuminate the central light 129a. As braking pressure 123 is increased, the light array 128a would be illuminated, lamp 120n by lamp 120n, in direct proportion to the hydraulic braking pressure 123 exerted in the brake system 121, or the magnitude of the velocity input data generated by the velocity measuring device. A continuous sequential illumination of the lights 120n from center light 129a outwards occurs in proportion to the increase or decrease of velocity change or pressure 123.

The advantage of the present invention, which has been described in detail above, is that brake light system contemplated herein not only expands the data that is available from existent brake light systems that convey only on-off data, but indicates not only when the brake system is activated, but also the degree to which the system is activated, and more importantly, is not prone to serious error and inaccurate array illumination data since the major characteristic contemplated herein is that the array illumination is dependent on a velocity measuring device, and not on a fallible mechanical, hydraulic, or pneumatic braking system.

The brake signaling system of the invention provides a real time dynamic portrayal of the level of activation of the hydraulic braking system to assist a motorist behind in determining the appropriate amount of braking force that is needed to maintain control and safety relative to the preceding lead or front motorist. Through communication of more relevant data to the following motorist regarding the braking activity in the leading vehicle, a rear end collision can be avoided or minimized. The brake signaling system is thus very well suited for safer high-speed congested expressway driving where time, distance, deceleration rate and reaction time are critical.

The foregoing represents a description of preferred embodiments. Variations and modifications of the embodiments described and shown herein will be apparent to persons skilled in the art, without departing from the inventive concepts disclosed herein. All such variations and modifications are intended to be within the scope of the invention, as defined in the following claims.

What is claimed is:

1. A lighting system on a motor vehicle, comprising:
(a) an array of light emitting elements;
(b) a velocity measuring device;
(c) communicating means between said velocity measuring device and said array;
wherein said velocity measuring device communicates a decrease in velocity of said vehicle through said communicating means, and said decrease causes a sequential illumination of said light emitting elements.

2. The lighting system of claim 1, wherein said communicating means is a brake light processing unit.

3. The lighting system of claim 2, wherein said brake light processing unit further comprises:
(a) a system clock;
(b) a velocity measuring device data interface;
(c) a pulse generator;
(d) at least two memory latches;
(e) a deceleration level detector; and
(f) a brake light interface;
wherein said velocity measuring device provides velocity data which is processed by said velocity measuring device data interface, said clock, said pulse generator, said at least two memory latches, said deceleration level detector, and said brake light interface to sequentially illuminate said array.

4. The lighting system of claim 1, further comprising:
(a) a brake pedal that depresses to produce a change in pressure; and
(b) a brake pedal switch unit that transmits said change in pressure to said array;
wherein said change in pressure causes said array to illuminate sequentially.

5. The lighting system of claim 1, wherein said array is arranged in a linear fashion.

6. The lighting system of claim 1, wherein said array is arranged in a circular fashion.

7. The lighting system of claim 1, wherein said array is arranged in a concentric fashion.

8. The lighting system of claim 1, wherein said array is a radial formation.

9. The lighting system of claim 1, wherein said array comprises a center light emitting element and at least two other light emitting elements, said central light emitting element supplying the current for said at least two other light emitting elements.

10. The lighting system of claim 1, wherein said measuring device is a speedometer.

11. The lighting system of claim 1, wherein said measuring device is an accelerometer.

12. The lighting system of claim 1, wherein said measuring device is a global positioning system (GPS).

13. The lighting system of claim 1, wherein said measuring device is an anti-lock braking system (ABS).

14. The lighting system of claim 1, wherein said measuring device is an opto-switch.

15. A method for brake lighting a motor vehicle, comprising the steps of:
(a) measuring a change in velocity of said motor vehicle with a measuring device;
(b) communicating through a communicating means said change in velocity to an array of light emitting elements;
(c) illuminating sequentially said array of light emitting elements due to said change in velocity.

16. The method of claim 15, wherein said communicating means is a brake light processing unit.

17. The method of claim 16, wherein said brake light processing unit further comprises:
(a) a system clock;
(b) a velocity measuring device data interface;
(c) a pulse generator;
(d) at least two memory latches;
(e) a deceleration level detector; and
(f) a brake light interface.
wherein said velocity measuring device provides velocity data which is processed by said velocity measuring device data interface, said clock, said pulse generator, said at least two memory latches, said deceleration level detector, and said brake light interface to sequentially illuminate said array.

18. The method of claim 15, further comprising the steps of:
(a) depressing a brake pedal to produce a change in pressure; and
(b) communicating a change in pressure using a brake pedal switch unit to said array;
wherein said change in pressure causes said array to illuminate sequentially.

19. The method of claim 15, wherein said array is arranged in a linear fashion.

20. The method of claim 15, wherein said array is arranged in a circular fashion.

21. The method of claim 15, wherein said array is arranged in a concentric fashion.

22. The method of claim 15, wherein said array is arranged in a radial formation.

23. The method of claim 15, wherein said array comprises a center light emitting element and at least two other light emitting elements, said central light emitting element supplying the current for said at least two other light emitting elements.

24. The method of claim 15, wherein said measuring device is a speedometer.

25. The method of claim 15, wherein said measuring device is an accelerometer.

26. The method of claim 15, wherein said measuring device is a global positioning system (GPS).

27. The method of claim 15, wherein said measuring device is an anti-lock braking system (ABS).

28. The method of claim 15, wherein said measuring device is an opto-switch.
